(19) United States
(12) Patent Application Publication
(10) Pub. No.: US 2022/0268438 A9
(43) Pub. Date: Aug. 25, 2022

(54) Specialty Punt Illumining Light Tool

(71) Applicant: Michael Hintz, Oakdale, CT (US)

(72) Inventor: Michael Hintz, Oakdale, CT (US)

(21) Appl. No.: 17/013,787

(22) Filed: Sep. 7, 2020

Related U.S. Application Data
(63) Continuation of application No. 16/237,706, filed on Jan. 1, 2019, now abandoned.

(51) Int. Cl. F21V 33/00; F21L 4/00; F21S 10/00

(52) U.S. Cl. CPC F21V 33/0036; F21L 4/00; F21S 10/002; F21Y 2115/10

(57) ABSTRACT

Brief Summary: The claim in simple terms is the simple ultraviolet illuminating device and its location underneath the specialized liquid in the bottle making the complete invention, however not obvious because it has not here before been an item of commerce. Again, not limited to the example described but for illustrative purposes the invention in its principle shall be described. Since the device will work with the intrinsic property of the chemical in the specialized liquid, those skilled in the art will appreciate the chemical quinine dissolved in water as an example, will fluoresce with UV light. The claim is not for the specialized liquid, but for the device, which is held under the vessel, which requires the aforementioned specialized liquid to be held in the vessel. Clearly the device itself will illuminate what shines in its path, but the device's purpose is to illuminate the matter as described.

This invention is intended to illuminate the vessel from below for cosmetic or aesthetic purposes. Ideally the machine is built to fit self contained within the void in the bottom of the vessel for practical purposes but can be adapted with a base collar to contain the apparatus and attach to the vessel. This novel, unprecedented invention consists of several components working in concert to create a specific illumined event with a specialized liquid contained in a flask. Those skilled in the arts will recognize a flashlight, LED, battery, and glass or vessel to hold any liquid have all been precedented. This invention covers the placement of said specialized liquid in said glass or vessel as described in the attached diagrams to illicit the illumination broadly described in this application. Moreover, not limited to the example described, is the claim of a specialized liquid subjected to UV radiation to cause that specialized liquid to fluoresce inside its container via the second part of said invention placed underneath the vessel. Each component is dependent upon the other. The claim is for a device described in detail and shown in FIGS. 1 and 2 comprising: component one which is a diffusion layer, component two which is an ultraviolet filter, component three which is a light emitting diode (LED) or LED array, component four a solid support, component five a battery, component six a battery holder, component seven a spacer, component eight a reflective material, component nine an adhesive and component ten an on/off switch, held under the glass or container, or vessel which will cause a special and specific illumination or fluorescing. The specialized liquid as described is, for example, a potable drink such as an alcoholic beverage. By adding fluorescing compound or compounds to the specialized liquid while passing Ultraviolet (UV) light via the invention through the glass or container or vessel affixed or held from below the specialized liquid will transmogrify the specialized liquid to said effect; namely fluorescing or phosphorescing.

This claim will cover the required generally regarded as safe (GRAS) compound in the specialized liquid, used with the described vessel, and the required illumination apparatus; each part of the invention claim.

### FIELD

This relates to an invention that will illumine a specific vessel with a punt using the device or tool.

### BACKGROUND

This is a new application for a new patent with no prior application background. Appendix referring to prior art. Please see U.S. Pat. Nos. 10,156,326; 6,095,661; 7,147,343; 7,972,030; 7,224,000; 7,980,747; 4,719,159; 5,154,989; 9,911,870; 3,655,452

### SUMMARY

The Specialty Punt Illumining Light Tool (SPILT) is constructed in a way that allows the device to shine from the bottom of a vessel thus illumining the specialized liquid above. It, the SPILT is fitted to the bottom of the vessel and when turned on will make the (new) specialized liquid in the vessel appear to glow.

The invention should not be limited except for the mentioned claims and their equivalents. The illustrations described will explain how the device can and will function.

### BRIEF DESCRIPTION OF DRAWINGS

Several drawing are here presented to describe the invention. Since the vessel is not part of the invention, fitment and dimensions are not completely detailed. For a matter of reference, the void described is likely one half to three quarters of an inch at the apex so the device is no thicker or taller than the vessel void. An alternate arrangement can be constructed with a suitable collar to hold said machine.

FIG. 1 shows A: a clear glass bottle like a wine glass that has a punt or void in the bottom and is neither frosted or opaque; B: is a clear glass again containing a bottom punt or concave void at the bottom; C: is a clear glass similar to a champagne glass or wine flute which also must have a void in the bottom. The device is designed to fit into or within said void as described.

FIG. 2 shows the invention in its entirety but not to scale.

FIG. 3 shows the breakdown components in an exploded view.

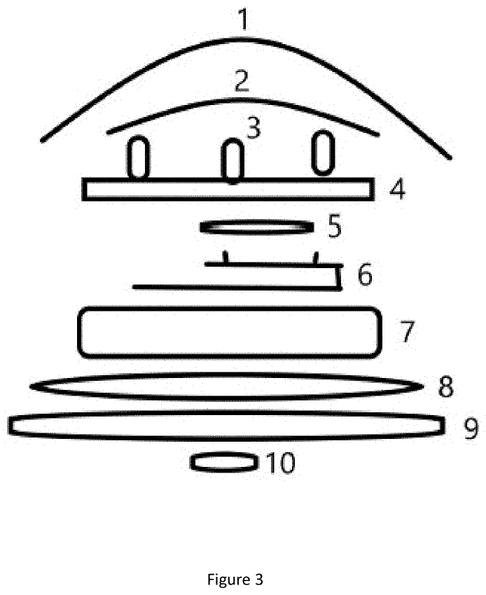

FIG. 4 A shows a partial side view while B shows a partial bottom view.

### DETAILED DESCRIPTION

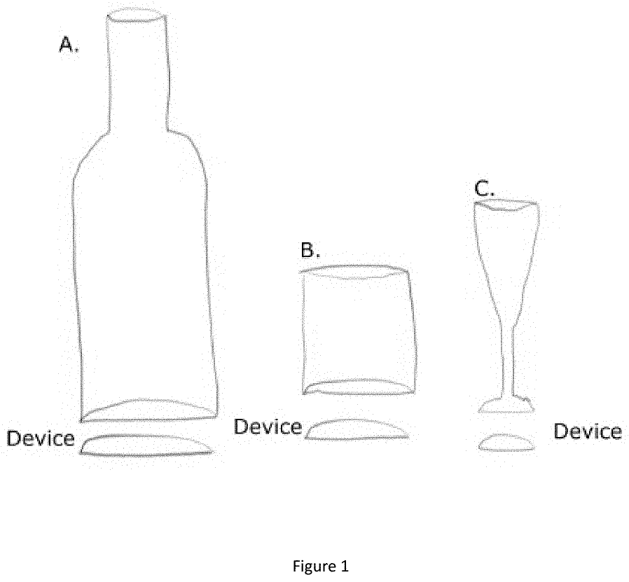

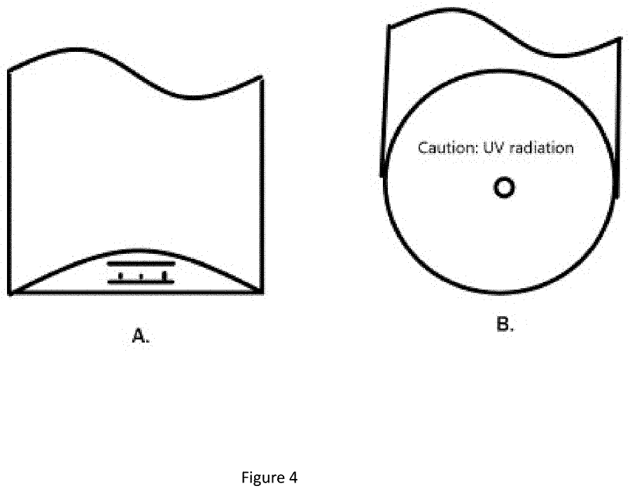

Specifically FIG. 1A is a clear wine bottle with a manufactured punt. The bottle should not be frosted or opaque to maximize the luminosity of the specialized liquid that will be contained within. FIG. 1B is a clear drinking glass with a bottom void or punt similar in design to the wine bottle facilitating the insertion of the invention. FIG. 1C is a clear wine glass or champagne flute manufactured with a bottom void or punt where the invention can be contained. The purpose of this setup will be explained in the claims section. For clarity ‘Device’ refers to the invention being claimed. FIG. 4 is the device shown in place on the bottom of a vessel, from (A.) a side view perspective and then (B.) a bottom view perspective.

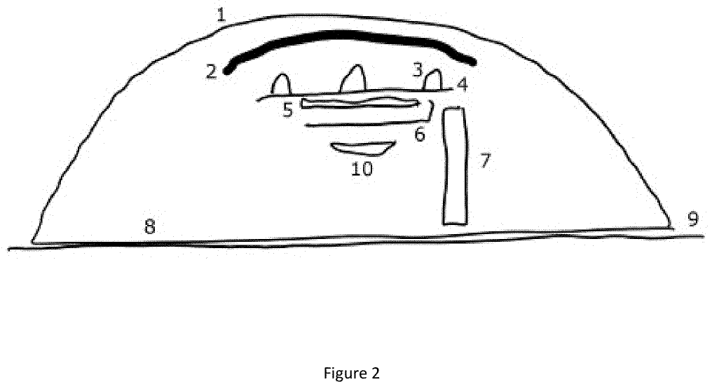

FIG. 2 and its parts shall be described in this section. Since figure two and figure three are equivalent in their numbering, only one description is necessary for both. 1 is a diffusion layer that will be closest to the glass. Shining a light directly as with a LED light will result in collimated beam which is less desirable. The diffusion material will act to disperse the light beam from the LED or LED array so the entire contents of the glass vessel will be illuminated. 2 is an ultraviolet filter which will allow only ultraviolet wavelength light to pass beyond this filter. This filter is placed in front of the LED light bulb or bulbs and is essential to the invention because of the concerted action of the light with the specialized liquid contained in the glass vessel to be explained in the claim. 3 is a lightemitting diode (LED) or LED array as per the spacial arrangement and volume of the cylinder; read, a wine glass may require as few as one LED while a wine bottle may require up to a half dozen or dozen LEDs for the required illumination of the specialized liquid contained. 4 is a solid support or circuit board to contain the LEDs. The use of a circuit board affords variation in the utility of the device. For instance, the LED array on the circuit board will allow for timing or simplifying the addition of an on/off switch installation. 5 is the battery power supply or multiple batteries used for power. 6 is the holder for the battery or batteries that will be attached to the solid support. 7 is a spacer.

Depending on the geometry of the punt, a spacer or support of different size may be needed to hold together the components of the invention. 8 is a reflective material or foil such that stray light will be reflected or deflected back up towards the UV (ultraviolet) filter and through it and the diffuser towards the specialized liquid. 9 is adhesive material on a backer that will hold the invention fast to whichever vessel is used. This material can range from the width of the vessel to slightly larger than the vessel width in order to facilitate the fitment of the device, such that this piece might constitute a base piece attached firmly to the glass or vessel. 10 is an on/off switch to be contained on the device such that the device light will be on only when in use. This makes the device recyclable such that it can be removed from the vessel and reused instead of being discarded. This completes the description of the invention but does not completely clarify the claim of the device.

Figure three, see above. Figure three is the exploded view of figure two and is functionally equivalent.

FIG. 4 is the device shown in place on the bottom of a vessel, from (A.) a side view perspective and then (B.) a bottom view perspective.

1. A specialty punt illuminating light tool device comprising: a diffusion layer in a conforming void which is configured to be fitted to the bottom of a punt or cavity of a drinking vessel, an ultraviolet filter of said purpose that only allows ultraviolet wavelength to pass is arranged between the LED or LED array and the diffusion layer contained in the void, wherein light from a light emitting diode (LED) or LED array passes through the filter to illuminate a specialized liquid containing a (GRAS) generally regarded as safe chemical that the ultraviolet light causes to fluoresce also in the void, a solid support or board or electronics board containing the LED or LED array in the void, a battery or batteries configured to power the LED or LED array in the void arranged on a compartment to hold the battery or batteries within the void cavity, wherein a spacer is arranged within the cavity to hold individual components and to maintain the shape of the cavity, a reflective material attached on the opposite side of the void to form a cavity; a switch capable of activating or deactivating the device arranged within the cavity and an adhesive material to attach the illuminating device to the bottom of the punt or drinking vessel, or vessel.

2. The specialty punt illuminating light tool device of claim 1 wherein the LED or LED array is located underneath the specialized liquid is activated by the switch and powered by the battery, the LED or LED array emits ultraviolet light that illuminates the specialized liquid or chemical in the liquid thus causing the specialized liquid or chemical to fluoresce.

3. The specialty punt illuminating light tool device of claim 1 consisting of the chemical in the specialized liquid, or the generally regarded as safe (GRAS) liquid for clarity which may be consumed held within the vessel, the specialized liquid being contained in vessel when illuminated by the ultraviolet radiation will cause the specialized liquid to fluoresce or glow as quinine dissolved in liquid will fluoresce when illuminated with ultraviolet light.
